(19) United States
(12) Patent Application Publication
(10) Pub. No.: US 2005/0232095 A1
(43) Pub. Date: Oct. 20, 2005

(54) Optical pickup device

(75) Inventors: Shota Okamoto, Saitama (JP); Takehiro Motegi, Saitama (JP)

Correspondence Address: FOLEY AND LARDNER;SUITE 500, 3000 K STREET NW, WASHINGTON, DC, 20007, US

(73) Assignee: PIONEER CORPORATION

(21) Appl. No.: 11/083,104

(22) Filed: Mar. 18, 2005

(30) Foreign Application Priority Data
Mar. 30, 2004 (JP) 2004-098762

(51) Int. Cl. G11B 7/00

(52) U.S. Cl. 369/44.11

(57) ABSTRACT

A grounded pickup body 40 and a flexible-printed circuit board (FPC) are provided 10. On the reverse side of the FPC 10, a plurality of protruding lands 30 is connected to a ground pattern. The FPC 10 is wrapped around the pickup body 40, and a part of the FPC 10 is fixed to the pickup body 40. Thus, the plurality of protruding lands 30 makes electrical contact with the pickup body 40. As a result, ground reinforcement of the FPC 10 can be efficiently attained at low cost.

### BACKGROUND OF THE INVENTION

1) Field of the Invention

The present invention relates to an optical pickup device including a pickup body and a flexible-printed circuit board. More specifically, the present invention relates to ground reinforcement of the flexible-printed circuit board.

2) Description of the Related Art

Optical recording/reproducing devices that record data in and reproduce data from optical discs such as compact discs (CDs) and digital versatile discs (DVDs) include an optical pickup body installed with an optical system used for recording and reproducing. The optical pickup body is movably arranged on an external substrate (chassis) of the optical recording/reproducing device, so as to move along the diameter of an optical disc.

A typical optical pickup body includes a semiconductor laser as a light source, a light-sensitive element that senses return light from an optical disc and monitors laser power, and an actuator that moves an objective lens in a focusing direction and along the diameter of an optical disc. These components need to receive power, and transmit/receive control signals.

The semiconductor laser, the light-sensitive element, the actuator, and corresponding peripheral integrated circuits (ICs) are connected to the external substrate via a flexible-printed circuit board. The components of the optical pickup body receive power from and transmit/receive control signals to/from the external substrate via the flexible-printed circuit board.

In recent years, to make optical pickup bodies lighter and more compact, the peripheral ICs etc. are often mounted on a flexible-printed circuit board. To stabilize the electric characteristics of the components mounted on the flexible-printed circuit board, and to effectively reduce radiant noise emitted from the semiconductor laser and a corresponding driving circuit, it is preferable that the ground pattern in the flexible-printed circuit board has low ground impedance. To achieve such low ground impedance, the flexible-printed circuit board is typically multilayered, and a ground is provided on a plurality of layers. However, this method requires many processing steps, which leads to increased cost.

Japanese Patent Application Laid Open No. 2003-257063 discloses a method of providing ground patterns on two layers, and connecting these ground patterns with a through-hole to increase the area of the ground. Japanese Patent Application Laid Open No. 2003-257063 discloses another method of exposing a part of a ground pattern on a single-layer flexible-printed circuit board as a shield pattern, and forming one recessed land connecting to the ground pattern with a solder coating. The recessed land is then connected to a carriage unit with a screw, so that the ground is at one point, where the ground pattern of the flexible-printed circuit board and the carriage unit are connected.

The method disclosed in Japanese Patent Application Laid Open No. 2003-257063 of making a multilayered flexible-printed circuit board and providing a ground on a plurality of layers, requires many processing steps, which leads to increased cost, as described earlier.

The method disclosed in Japanese Patent Application Laid Open No. 2003-257063 includes connecting the ground pattern and the carriage unit via the recessed land and the screw. In this case, the ground impedance cannot be lowered much; because, the ground pattern and the carriage unit are connected at one point. As a countermeasure, a plurality of recessed lands can be formed and connected to the carriage unit with screws. In this case, the flexible-printed circuit board needs to be screw-fixed to the carriage unit at many points. Therefore, a plurality of screw holes is required on the carriage unit, which causes difficulty in designing the carriage unit. Moreover, a plurality of screws needs to be screwed into the holes when connecting the flexible-printed circuit board to the carriage unit. As a result, the processing becomes complicated and inefficient.

### SUMMARY OF THE INVENTION

The present invention has been made in view of the above described problems. Accordingly, it is an object of the present invention to provide an optical pickup device in which ground reinforcement of a flexible-printed circuit board is performed at low cost and in an efficient manner.

To solve the above described problems and to achieve the above described object, the present invention provides an optical pickup device including a pickup body that includes a light-emitting unit and a light-receiving unit, and a flexible-printed circuit board electrically connected to the light-emitting unit and the light-receiving unit, wherein the flexible-printed circuit board includes a plurality of protruding lands connected to a ground pattern in the flexible-printed circuit board, and the flexible-printed circuit board is attached to the pickup body, so that the plurality of protruding lands contacts the pickup body.

The other objects, features, and advantages of the present invention are specifically set forth in or will become apparent from the following detailed description of the invention when read in conjunction with the accompanying drawings.

### BRIEF DESCRIPTION OF THE DRAWINGS

FIGS. 1A and 1B are expansion diagrams of respectively a front side and a reverse side of a flexible-printed circuit board;

FIG. 2 is a cross-sectional view of a protruding land on the flexible-printed circuit board shown in FIGS. 1A and 1B;

FIG. 3 is a cross-sectional view of a covered hole on the flexible-printed circuit board shown in FIGS. 1A and 1B;

FIGS. 4A and 4B are respectively a side view and a bottom view of a pickup body; and

FIGS. 5A and 5B are diagrams of the flexible-printed circuit board attached to the pickup body.

### DETAILED DESCRIPTION

Exemplary embodiments of an optical pickup device according to the present invention will be described below with reference to accompanying drawings.

A flexible-printed circuit board (hereinafter, “FPC”) according to the present invention is wrapped around a part of a pickup body and attached to the pickup body. Before the FPC and the pickup body are assembled, a plurality of protruding lands is formed on the reverse side of the FPC. The protruding lands are made of conductive material. The protruding lands connect to a ground pattern of the FPC. The protruding lands are made by forming covered holes at positions where there is the ground pattern, and filling the covered holes with, for example, solder. Covered holes are also formed on a signal line pattern and on the ground pattern for connecting to components installed in the pickup body such as a semiconductor laser, a light-sensitive element, or an actuator, or ground pins of corresponding peripheral ICs; however, solder is not filled into these covered holes at this point.

The assembling procedure followed for partially wrapping the FPC around the pickup body is performed as follows. The FPC is wrapped around the pickup body such that the reverse side of the FPC faces the pickup body. The FPC is then fixed to the pickup body with screws at dedicated fixing holes. Accordingly, the protruding lands contact the pickup body, so that the ground patterns of the FPC electrically contacts the grounded pickup body at multiple points.

Subsequently, as in conventional methods, solder is filled into the covered holes on the signal line pattern or on the ground pattern connecting to the components installed in the pickup body such as the semiconductor laser, the light-sensitive element, the actuator, or the ground pins of corresponding peripheral ICs in the pickup body, and then heat is applied to solder filled into these holes; however, heat is not applied to the protruding lands that contact the pickup body at multiple points.

The ground patterns can surely contact the pickup body if the protruding lands are located near the positions where the FPC is screw-fixed to the pickup body, or near and along a portion that allows easy bending of the FPC.

According to the embodiment, the protruding lands made of conductive material connecting to the ground pattern are formed on the reverse side of the FPC beforehand, so that the ground pattern of the FPC electrically contacts the pickup body at multiple points, only by wrapping and fixing the FPC around the pickup body. In this case, since there is no need to fix the FPC onto the pickup body with many screws, ground reinforcement of the FPC can be achieved by an easy processing that takes short time. As a result, electromagnetic interference (EMI) performance and electric performance of the optical pickup device can be improved at low cost.

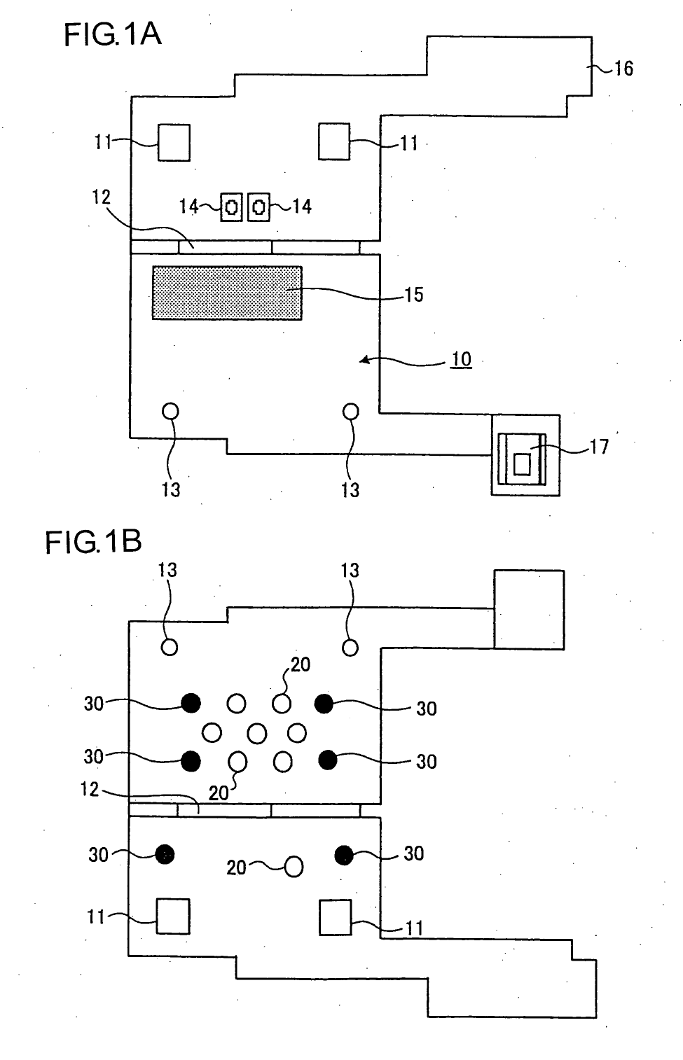

Next, a practical example according to the present invention is described with reference to FIGS. 1 to 5. FIG. 1A is an expansion diagram of a front side an FPC 10, and FIG. 1B is an expansion diagram of a reverse side of the FPC 10.

As shown in FIGS. 1A and 1B, the FPC 10 has openings 11, a bending portion 12, and two screw holes 13. As shown in FIG. 1A, the front side of the FPC 10 has variable resistance 14 that variably changes a driving current that drives a semiconductor laser installed in a pickup body, a connector 15 that connects the FPC 10 to another FPC to be connected to an external substrate (not shown), and an input/output terminal section 16. Moreover, a peripheral IC 17 is installed on the front side of the FPC.

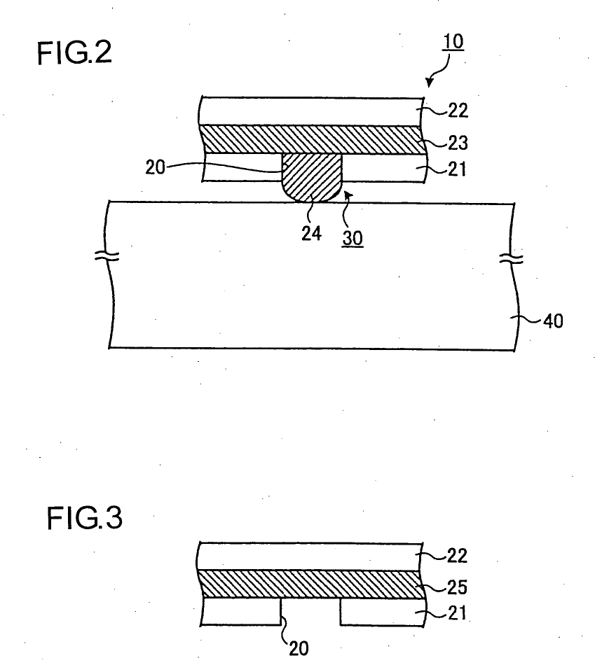

As shown in FIG. 1B, the reverse side of the FPC 10 has a plurality of covered holes 20. Some of the covered holes are filled with solder, forming protruding lands 30 represented by black circles. FIG. 2 is a cross-sectional view of one of the protruding lands 25. FIG. 2 is a cross-sectional view of one of the covered holes 20 that is not filled with solder.

As shown in FIGS. 2 and 3, the FPC 10 includes conductive patterns (ground pattern 23 and signal line pattern 25) and coatings 21 and 22. The coatings 21 and 22 are made of material such as resist or covering film they sandwich the conductive patterns. In the case shown in FIG. 2, the covered hole 20 is formed in a portion whether there is the ground pattern 23, and a solder bump 24 is formed by filing solder in the covered hole 20. The solder bump 24 protrudes from the coating 21 on the reverse side of the FPC 10.

On the other hand, as shown in FIG. 3, the covered hole 20 positioned in a portion where there is the signal line pattern 25 is not filed with solder. The protruding lands 30 are formed on the FPC 10 before attaching the FPC 10 to a pickup body 40.

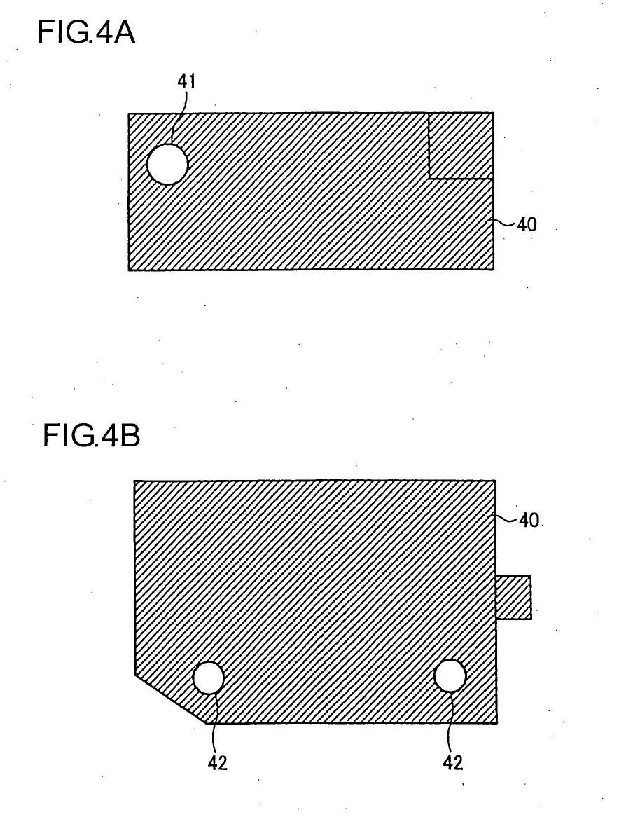

FIG. 4A is a side view of the pickup body 40. The pickup body 40 is made of conductive material such as metal. FIG. 4B is a bottom view of the pickup body 40. As shown in FIG. 4A, there is a shaft receiving section 41 on the side of the pickup body 40, into which a guiding shaft (not shown) is inserted. The pickup body 40 slides over the guiding shaft along the diameter of an optical disc. The guiding shaft is fixed to the external substrate (chassis), not shown. The pickup body 40 is movably arranged on the external substrate. The pickup body 40 is grounded. More precisely, the external substrate is grounded, and the pickup body 40 is electrically connected to the external substrate. As shown in FIG. 4B, the bottom side of the pickup body 40 has two screw holes 42, into which screws are inserted to fix the FPC 10.

The pickup body 40 includes a semiconductor laser as a light-emitting unit, a light-receiving unit that senses return light from an optical disc and monitors laser power, and an actuator that moves an objective lens in a focusing direction and along the diameter of an optical disc. These components need to receive power, and transmit/receive control signals via the FPC 10.

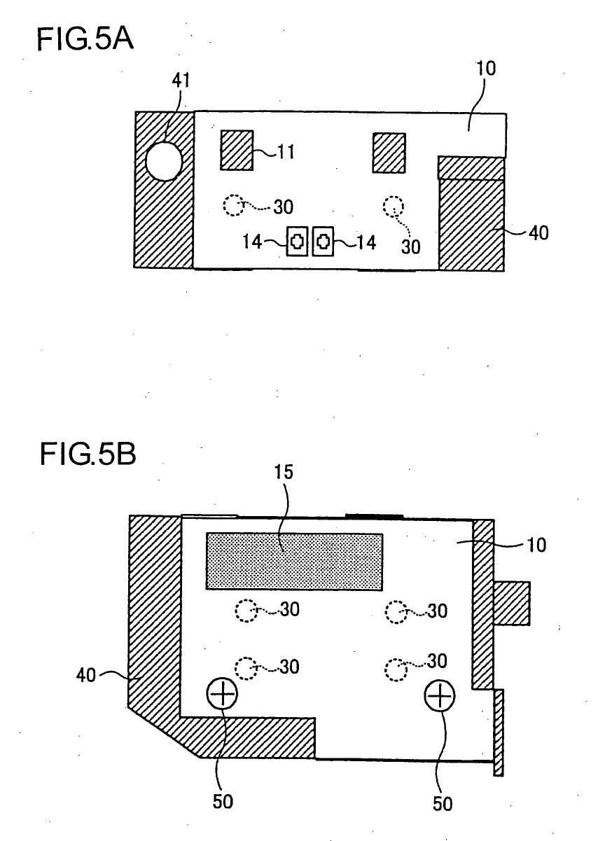

FIG. 5A and FIG. 5B are diagrams of the FPC 10 attached to the pickup body 40. FIG. 5A is a side view, and 5B is a bottom view. In the assembling procedure, the FPC 10 is wrapped around the pickup body 40 such that the reverse side of the FPC 10 faces the pickup body 40. The screw holes 13 of the FPC 10 are positioned on the screw holes 42 of the pickup body 40, and screws 50 are inserted in these screw holes 13, 42 to fix the FPC 10 to the pickup body 40.

As a result, the plurality of protruding lands 30 formed on the reverse side of the FPC 10 contacts the grounded pickup body 40, as shown with the example in FIG. 2. Thus, the ground pattern 23 of the FPC 10 makes electrical contact with the pickup body 40 at multiple points.

As described in the practical example, the plurality of protruding lands 30 connecting to the ground pattern 23 is previously formed on the reverse side of the FPC 10. Thus, the FPC 10 is wrapped and fixed around the pickup body 40, so that the ground pattern 23 of the FPC 10 makes electrical contact with the pickup body 40 at multiple points. In this case, since there is no need to fix the FPC 10 onto the pickup body 40 with many screws, ground impedance of the FPC 10 can be easily lowered by a processing that takes short time. As a result, EMI performance and electric performance of an optical pickup device can be improved at low cost.

Any conductive material other than solder can be used for the protruding lands 30, such as conductive adhesives. The same FPC 10 can be attached to the pickup bodies 40 that have different shapes and sizes. In this case, the FPC 10 is formed such that the protruding lands 30 are provided at positions that are common to the pickup bodies 40 of different shapes and sizes. Thus, the same FPC 10 can be used for ground reinforcement of the pickup bodies 40 that have different shapes and sizes.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. An optical pickup device comprising.
a pickup body that includes a fight-emitting unit and a light-receiving unit; and
a flexible-printed circuit board that is electrically connected to both the light-emitting unit and the light-receiving unit, wherein the flexible-printed circuit board includes a ground pattern and a plurality of protruding lands electrically connected to a ground pattern, and the flexible-printed circuit board being attached to the pickup body in such a manner that the protruding lands make electrical contact with the pickup body.

2. The optical pickup device according to claim 1, wherein the protruding lands are located near a portion where the flexible-printed circuit board is fixed to the pickup body.

3. The optical pickup device according to claim 1, wherein the flexible-printed circuit board includes a portion that allows easy bending of the flexible-printed circuit board, and the protruding lands are located near and along the portion.

4. The optical pickup device according to claim 1, wherein the protruding lands are formed by filling solder in covered holes.

5. The optical pickup device according to claim 1, wherein, when the flexible-printed circuit board is attached to the pickup body the flexible printed circuit board partially wraps the pickup body.

6. The optical pickup device according to claim 1, wherein the flexible-printed circuit board is formed such that the protruding lands are provided at positions that are common to pickup bodies of different shapes and sizes.
